(19) United States
(12) Patent Application Publication
(10) Pub. No.: US 2023/0302678 A1
(43) Pub. Date: Sep. 28, 2023

(54) POSITIONER TABLE

(71) Applicant: AES ELEKTRONIK MAKINA SANAYI VE TICARET ANONIM SIRKETI, Nilüfer, Bursa (TR)

(72) Inventors: Sertan TOKTAS, Nilüfer, Bursa (TR); Serhat KESiCi, Nilüfer, Bursa (TR); Hakan ASA, Nilüfer, Bursa (TR)

(21) Appl. No.: 18/043,600

(22) PCT Filed: May 20, 2022
(86) PCT No.: PCT/TR2022/050453

§ 371 Date: Mar. 1, 2023

(30) Foreign Application Priority Data
May 21, 2021 (TR) 2021/008496

(51) Int. Cl. B27C 5/06; B23Q 1/03

(52) U.S. Cl. CPC B27C 5/06; B23Q 1/03; B27C 9/04

(57) ABSTRACT

Disclosed is an apparatus for the connection of one or more panels to a building element, the apparatus including: a support profile, provided with an anchor base fixed to an installation surface of the building element, a first and a second wing and a cavity, which acts as a seat-for at least a portion or edge of the panel; a system designed to adjust the laying set-up of the panel with respect to the support profile, so as to adjust the inclination of the panel with respect to the building element or to panels adjacent thereto. The laying set-up adjustment system of the panel provides an adjustment assembly, capable of providing the edge of the panel with a controllable rotation around a fulcrum and of adjusting the inclination of said panel.

### FIELD OF THE INVENTION

The present invention relates to a positioner table for automatically positioning a workpiece on sliding wood processing machines to allow for five - surface processing of the workpiece.

More specifically, the invention relates to a positioner table which ensures accuracy in machining dimensions through reaching the full limits of workpiece dimensions by way of an auto - positioning processing table and also prevents damage to workpiece surface.

### PRIOR ART

Wood processing machines are used for mass production processing of wood, furniture and all sorts of wood products. Sliding wood processing machines typically deliver surface machining through drilling, cutting, etc. operations on the wood workpiece placed over a fixed machining table.

In existing applications, fixed machining tables used in sliding wood processing machines lead to limitations in machining dimensions. In addition, during the machining of the side surfaces of a workpiece, the processing table is limited to top surface level, or the spindle damages the table surface. Limitations in machining dimensions due to a fixed machining table causes deformation in the spindle, spindle purges negatively affect the machining accuracy of the machine, and the machining capacity of the machine becomes limited. Moreover, the machining table can degrade over time, further necessitating replacement of the machining table. This leads to increased maintenance and repair costs in wood processing machines and loss of time in manufacturing. Furthermore, deformations occur on visual and sensitive surfaces of the workpiece moving on the fixed machining table, which, in turn, causes scrapping of workpieces after many pre - processing operations, resulting in loss of production.

Upon review of the literature, patent application numbered TR2016/15357 stands out as an example of prior art Said document relates to a wood processing machine. More specifically, the invention relates to a wood processing machine that enables drilling chipboards, MDFs, particleboards and similar boards used in modular furniture manufacturing, panel door sizing, making holes for connectors, making patterns on top surfaces, making holes for door frame connectors, etc. processing operations in two axes, namely X and Y axes, with software - supported manual adjustment capability or through data export from other manufacturing software, further comprising a dust extraction system. According to said invention, the workpiece is machined on a fixed stand assembly, which leads to problems in wood processing due to the fixed nature of the table.

In conclusion, the drawbacks explained above and the shortcoming in existing solutions to the problems have necessitated improvement in the related technical field.

### AIM OF THE INVENTION

The present invention relates to a positioner table which eliminates the disadvantages described above while bringing new benefits to the technical field.

The main aim of the invention is to ensure accuracy in machining dimensions through reaching the full limits of workpiece dimensions by way of an auto - positioning processing table.

Another aim of the invention is to provide the spindle with the means to reach all surfaces of a workpiece and machine all visible surfaces of the workpiece by changing position depending on the machining dimensions of the machining table and the final position of the spindle.

Another aim of the invention is to prevent errors of measurement that may occur during machining by way of maintaining the reference position of the machining table under the workpiece in cases where no position change is required and also maintaining the accuracy of machining dimensions.

Yet another aim of the invention is to prevent the workpiece from bending during vertical hole drilling operations, thereby eliminating the issue of deviation from the final dimensions due to bending by means of drill channels located on the machining table.

Another aim of the invention is to prevent potential deformations on the workpiece during machining by means of air flotation channels located on the machining table.

Still another aim of the invention is to protect the machining table surface during hole drilling operations from the bottom surface and provide a volumetric gap for hole drilling from the bottom edge of the side surface by means of the machining table which performs positioning by moving in upward / downward direction.

Yet another aim of the invention is to prevent damages to workpieces and eliminate losses in production.

In order to achieve the aims described above and all other aims that can be inferred from the detailed description, the invention relates to a positioner table for use in sliding wood processing machines, having the automatic positioning capability for machining of workpieces, comprising:
a bottom main table;
a machining table positioned on the bottom main table that changes position according to the machining position by moving in upward / downward direction over which wood workpieces are machined;
a vertical bearing which houses the machining table on the bottom main table and limits the positioning of the top surface of machining table according to bottom surface of the workpiece;
a drive system which moves the machining table on the bottom main table in upward / downward direction;
a stabilizer system which is connected to the bottom main table, levels the positioner table and keeps the positioner table stable during operation.

The below drawings and the detailed description set out with reference to the accompanying drawings provide for a clearer understanding of the structural and characteristic properties and all benefits of the present invention; therefore, the evaluation needs to take these drawings and the detailed description into account.

### BRIEF DESCRIPTION OF THE DRAWINGS

FIG. 1 is a perspective view of the positioner table according to the invention.

FIG. 2 is a side view of the positioner table according to the invention.

FIG. 3 is a top view of the positioner table according to the invention.

FIG. 4 is a perspective view of the positioner table of a wood processing machine according to the invention.

FIG. 5a is a view of the up position of the positioner table of a wood processing machine according to the invention during operation of the vertical axis spindle.

FIG. 5b is a view of the down position of the positioner table of a wood processing machine according to the invention during operation of the vertical axis spindle.

FIG. 6a is a view of the up position of the positioner table of a wood processing machine according to the invention during operation of the horizontal axis spindle.

FIG. 6b is a view of the down position of the positioner table of a wood processing machine according to the invention during operation of the horizontal axis spindle.

FIG. 7a is a view of the top position of the positioner table of a wood processing machine according to the invention during operation of the cutting tool.

FIG. 7b is a view of the down position of the positioner table of a wood processing machine according to the invention during operation of the cutting tool.

FIG. 8a is a view of the position of the positioner table of a wood processing machine according to the invention during operation of the cutting tool.

FIG. 8b is a view of the bottom position of the positioner table of a wood processing machine according to the invention during operation of the cutting tool.

List of Reference Numerals

| | |
|---|---|
| 10. | Bottom main table |
| 20. | Machining table |
| 21. | Drill channel |
| 22. | Air flotation channel |
| 30. | Vertical bearing |
| 40. | Drive system |
| 50. | Stabilizer system |
| A. | Positioner table |

### DETAILED DESCRIPTION OF THE INVENTION

In order to facilitate a better understanding of the present invention, this detailed description demonstrates the preferred embodiments of the positioner table (A) according to the invention in a non - limiting manner.

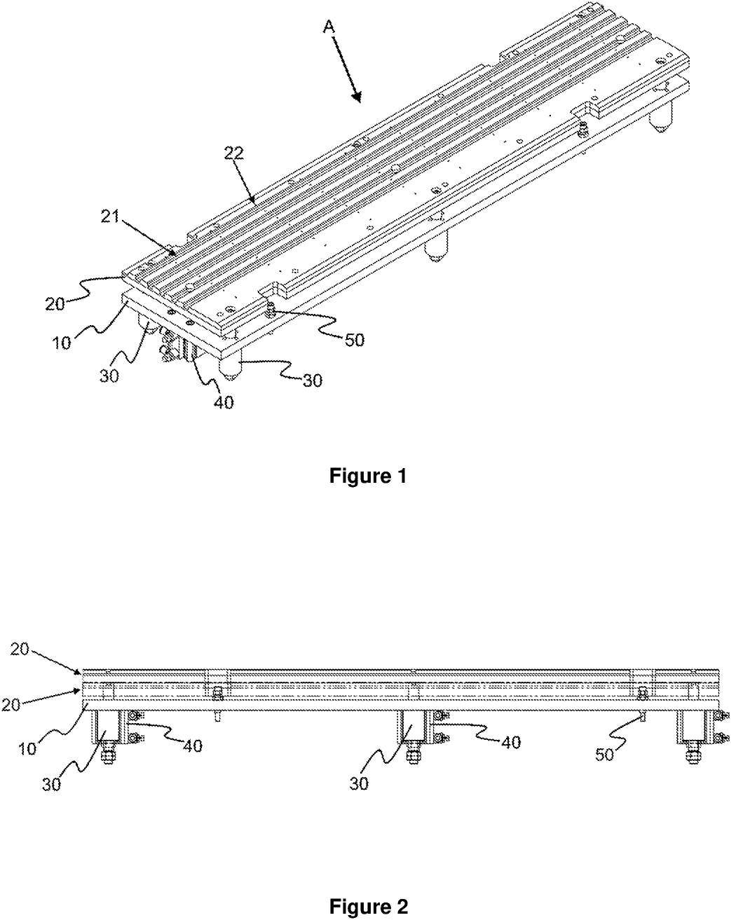

FIG. 1 shows an overall view of the positioner table (A) according to the invention. Accordingly, the positioner table (A) basically comprises a bottom main table (10), a machining table (20) which changes position by moving in upward / downward direction on the bottom main table (10) and over which wood workpieces are machines, a vertical bearing (30) which houses the machining table (20) on the bottom main table (10), a drive system (40) which moves the machining table (20) in upward / downward direction on the bottom main table (10), and a stabilizer system (50) which levels the positioner table (A) and keeps the positioner table (A) stable during operation.

The machining table (20) is housed on the bottom main table (10) that constitutes the main structure of the positioner table (A) by means of the vertical bearing (30). Said machining table (20) is the surface where the wood workpiece is machined and protects the surfaces of the moving workpiece.

As shown in FIG. 2, the machining table (20) changes position according to the machining position by moving in upward / downward direction by means of the drive system (40) connected to the bottom surface of the bottom main table (10). The vertical bearing (30) which houses the machining table (20) on the bottom main table (10) limits the top surface of the machining table (20) according to the bottom surface of the workpiece during operation.

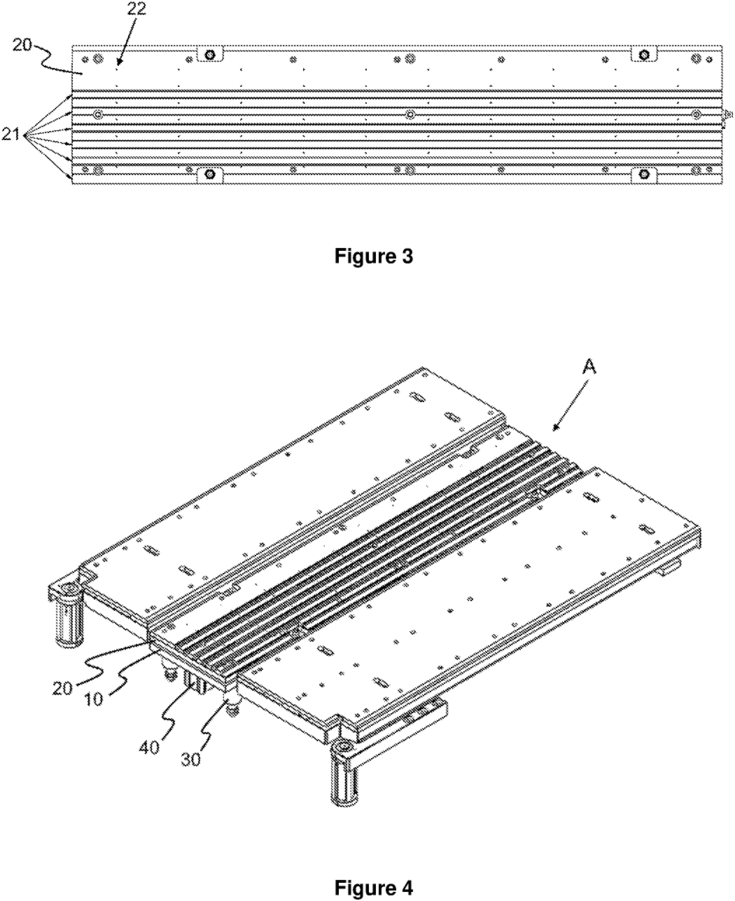

As shown in FIG. 3, drill channels (21) are formed longitudinally across the top surface of the machining table (20). Said drill channels (21) prevent the workpiece from bending during vertical hole drilling operations, thereby eliminating the issue of deviation from the final dimensions due to bending. In addition, air flotation channels (22) are formed in vertical axis on the surface of said machining table (20). Said air flotation channels (22) form a cushion on the contact surface between the workpiece and the machining table (20), thereby preventing deformation in the workpiece.

A stabilizer system (50) is connected to the bottom main table (10). The stabilizer system (50) levels the positioner table (A) and keeps it stable during operation.

As shown in FIG. 4, the positioner table (A) according to the invention works according to the following working principle:

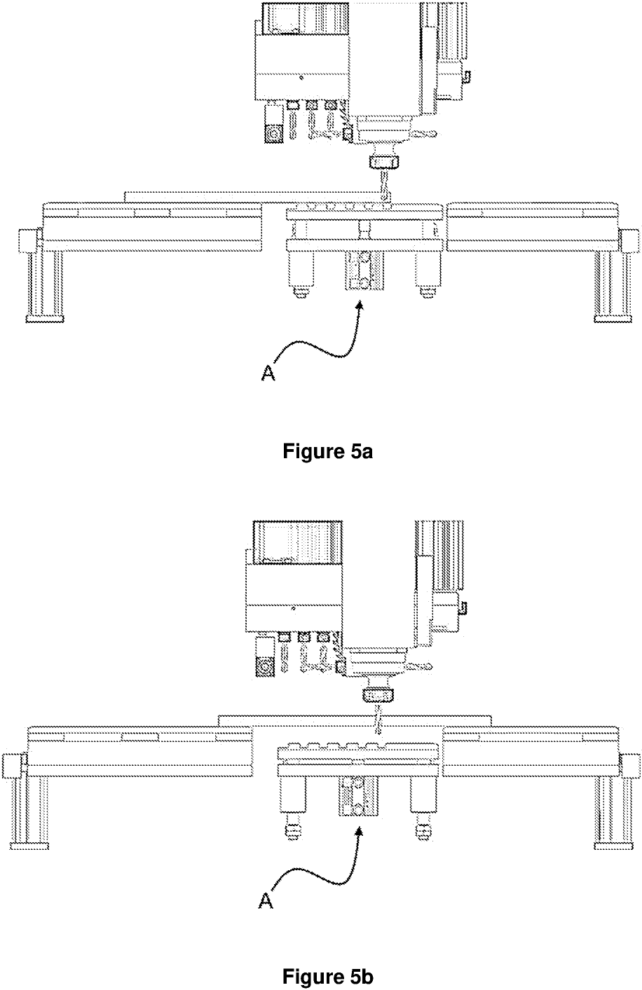

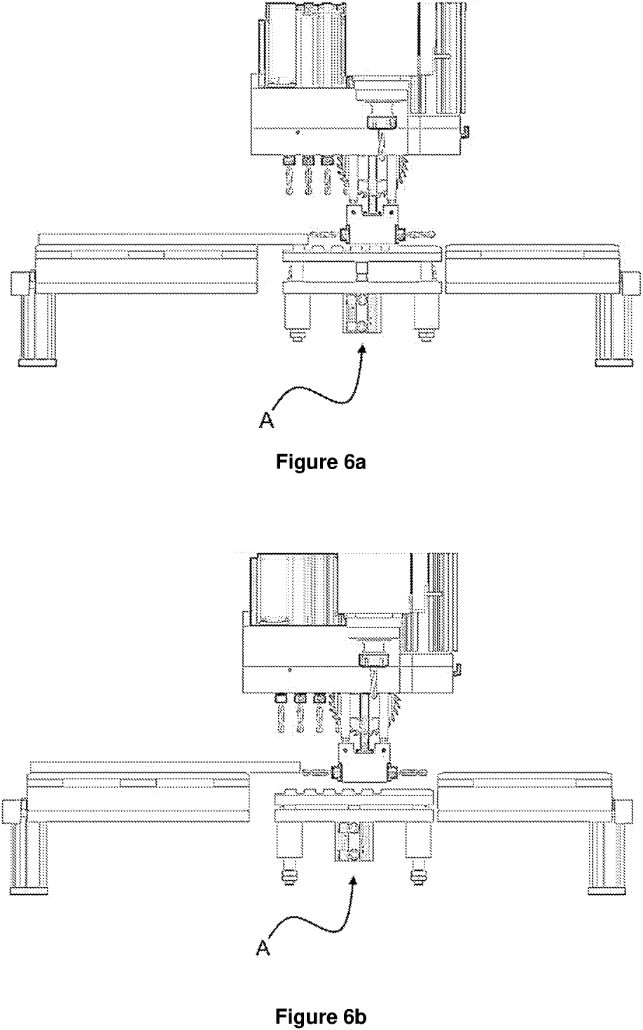

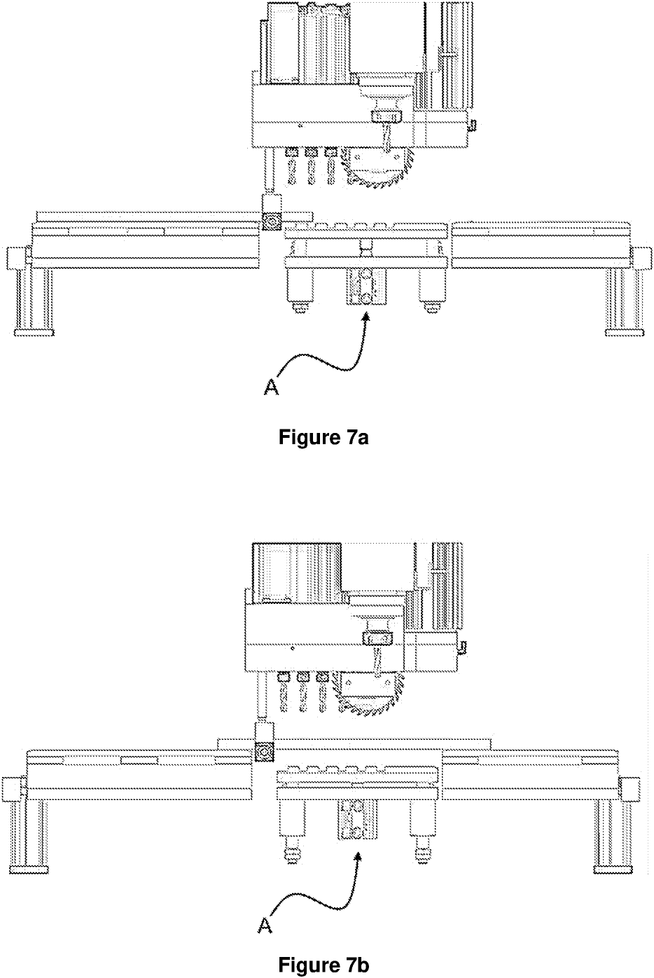

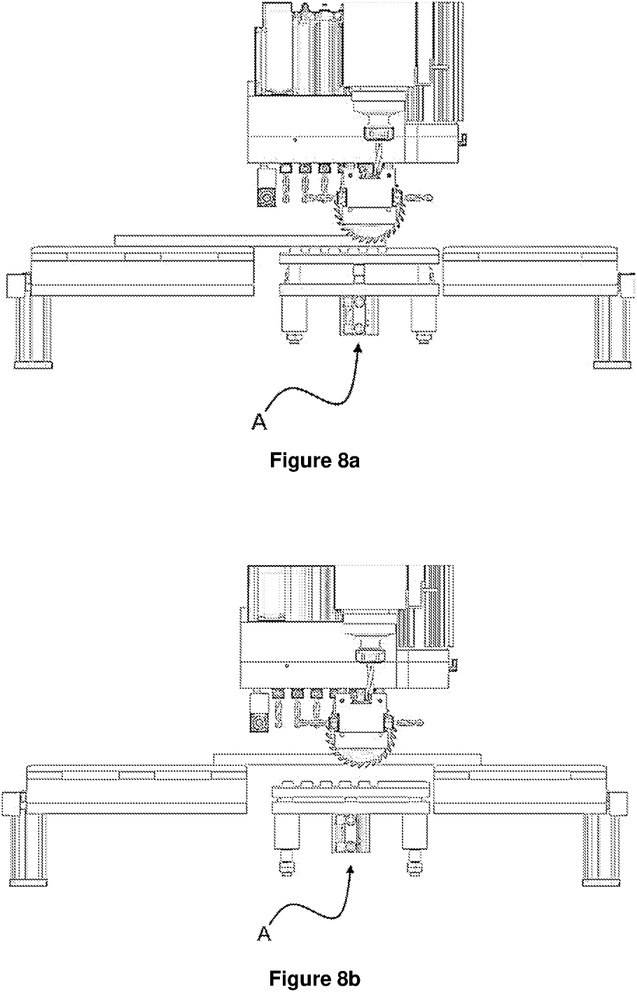

As shown in FIGS. 5a, 5b, 6a and 6b, the machining table (20) changes position by moving in upward / downward direction by means of the drive system (40) according to the final position of the vertical or horizontal axis spindle. As shown in FIGS. 7a, 7b, 8a and 8b, the machining table (20) also changes position by moving in upward / downward direction by means of the drive system (40) according to the position of the cutting tool during the cutting operation.

During operation, the machining table (20) takes an up position for machining dimensions above the ground surface level of the workpiece to maintain the accuracy of machining dimensions. In addition, a cushion is formed on the contact surface of the workpiece by way of air flotation channels (22) to prevent deformation in the workpiece. Drill channels (21) prevent the workpiece from bending during vertical hole drilling operations, thereby eliminating the issue of deviation from the final dimensions due to bending.

1. A positioner table for sliding wood processing machines, having the an automatic positioning capability for machining of workpieces, the positioner table comprising:
a bottom main table ;
a machining table positioned on the bottom main table that changes position according to the a machining position by moving in an upward / downward direction over which wood workpieces are machined;
a vertical bearing which houses the machining table on the bottom main table and limits the positioning of the top surface of machining table according to bottom surface of the workpiece; and
a drive system which moves the machining table on the bottom main table in upward / downward direction.

2. The positioner table according to claim 1, comprising; a stabilizer system which is connected to the bottom main table, levels the positioner table and keeps the positioner table stable during operation.

3. The positioner table according to claim 1, comprising; a drill channel which is formed longitudinally across the top surface of the machining table and prevents the workpiece from bending during vertical hole drilling operations.

4. The positioner table according to claim 1, comprising, an air flotation channel which is formed in vertical axis on the surface of said machining table and forms a cushion on the contact surface between the workpiece and the machining table, thereby preventing deformation in the workpiece.
